(19) United States
(12) Patent Application Publication
(10) Pub. No.: US 2005/0284989 A1
(43) Pub. Date: Dec. 29, 2005

(54) Heat-resistant clamp device for pipes or similar objects

(75) Inventor: Suguru Mizukoshi, Utsunomiya-shi (JP)

Correspondence Address: MILES & STOCKBRIDGE PC, 1751 PINNACLE DRIVE, SUITE 500, MCLEAN, VA, 22102-3833, US

(73) Assignee: Newfrey LLC

(21) Appl. No.: 11/156,536

(22) Filed: Jun. 21, 2005

(30) Foreign Application Priority Data
Jun. 28, 2004 (JP) 2004-189652

(51) Int. Cl. F16L 3/08; F16B 45/00

(52) U.S. Cl. 248/65; 248/71

(57) ABSTRACT

A clamp device for connecting a high-temperature elongated component to a support comprises a first clamp mountable to the support and a second clamp for holding the elongated component. The first clamp includes a clamp holder for holding the second clamp and is made of a non-heat-resistant hard plastic material. The second clamp includes a holder for holding the elongated component and is made of a heat-resistant hard plastic material. Preferably, the outer peripheral surface of the second clamp is covered by a layer of vibration-resistant elastic plastic material that prevents transmission of vibrations between an elongated component, such as a heater pipe, and a support, such as an under floor of an automobile.

### CROSS-REFERENCE TO RELATED APPLICATION

This application claims the benefit of Japanese Application No. 2004-189652 filed Jun. 28, 2004, incorporated herein by reference

### BACKGROUND OF THE INVENTION

The present invention relates to a heat-resistant clamp device enabling a high-temperature elongated component, such as a heater pipe, to be mounted on a support such as the underfloor of an automobile.

When metal clamps are used to mount a high-temperature elongated component such as a heater pipe to a support in an automobile, such as the underfloor, a considerable amount of labor is required to fasten nuts and bolts to the clamps. Also because metal clamps increase the weight of an automobile, they have increasingly been replaced by plastic clamps. When plastic clamps are used, however, the pipe has to be wrapped in a heat-resistant material, called an insulator, to block the transmission of heat from the pipe to the plastic clamps. A wrapped pipe is fixed to the clamp, which is then mounted on a support such as the underfloor.

A pipe clamp for holding automotive pipes is disclosed in Japanese Unexamined Utility Model Application Publication No. 62-118759 (Patent Document 1). This pipe clamp has a mechanism allowing a cover of the clamp to work together with rubber mounts to secure pipes held by the rubber mounts without the cover coming off a pipe, as may occur due to thermal deformation. The rubber mounts holding the pipes also prevent vibration between a pipe and the main body of the clamp. When the cover is closed, the rubber mounts are compressed, increasing the stress on the cover and making it difficult for the cover to become disengaged. Patent Document 1 does not disclose a configuration allowing a high-temperature elongated component such as a heater pipe to be held directly by the clamp.

A clamp device is disclosed in Japanese Unexamined Patent Application Publication No. 10-160047 (Patent Document 2) allowing a wire harness to be fixed to a support where the support is hot and vibrates. The clamp device in Patent Document 2 is rigid and consists of two semi-circular clamp components. The wire harness is wrapped in a buffering material consisting of a heat-resistant, vibration-resistant rubber. The outer peripheral surface of the semi-circular first clamp component is held by the semi-circular second clamp component, and both clamp components are connected and fixed to the support. Patent Document 2 does not disclose a configuration allowing a high-temperature elongated component such as a heater pipe to be held directly by the clamp.

A plastic clamp is desired that allows a high-temperature elongated component such as a heater pipe to be held directly by the clamp and to be mounted to a support such as an underfloor without having to wrap the elongated component in a heat-resistant material.

### BRIEF DESCRIPTION OF THE INVENTION

An object of the present invention is to provide a plastic heat-resistant clamp device able to directly hold a high-temperature elongated component such as a heater pipe without requiring any heat-insulating material.

In one non-limiting embodiment, the present invention is a clamp device for connecting an elongated component such as a heater pipe to a support in a car body, wherein the clamp device comprises a first clamp mountable to the support and a second clamp for holding an elongated component. The first clamp includes a clamp holder for accepting and holding the second clamp and a first cover connected via a hinge to the clamp holder for holding the second clamp in the clamp holder. The second clamp includes a pipe holder for accepting and holding the elongated component and a second cover connected via a hinge to the pipe holder for holding the elongated component in the pipe holder. The first clamp is made of a non-heat-resistant hard plastic material, and the second clamp is made of a heat-resistant hard plastic material able to hold a high-temperature elongated component.

In this embodiment, an elongated component such as a pipe is held directly by the second clamp made of a hard plastic heat-resistant material. As a result, a high-temperature elongated component such as a heater pipe does not have to be wrapped in a heat-resistant material. Because the first clamp is made of an inexpensive non-heat-resistant hard plastic material, the cost of the clamp device can be reduced and a stronger hard plastic material can be used. The elongated component such as a heater pipe is attached to the second clamp, and the first clamp is mounted holding the second clamp. By transporting the elongated component already attached to the clamp device to an automotive assembly line, labor can be saved on the assembly line.

In this clamp, the outer peripheral surface of the second clamp is preferably covered by a vibration-resistant elastic plastic covering material layer, and the first clamp preferably holds the second clamp via the covering material layer. This prevents vibrations from being transmitted between the elongated component and the support. When the first clamp holds the second clamp, the elastic material becomes compressed and a reactive force increases the retention strength. In addition, the second clamp can be insert molded with a vibration-resistant elastic plastic material to form a covering layer on the outer peripheral surface of the second clamp. Preferably, the first cover is configured so as to be able to latch the second clamp inside the clamp holder, and the second cover is preferably configured so as to be able to latch the elongated component inside the pipe holder. This improves mounting strength.

### BRIEF DESCRIPTION OF THE DRAWINGS

The invention will be further described in conjunction with the accompanying drawings, which illustrate preferred (best mode) embodiments, and wherein:

FIG. 1 is a front view of a clamp device in an example of the present invention;

FIG. 2 is a front view of heater pipes mounted on the underfloor of an automobile using the clamp device in FIG. 1;

FIG. 3 is a plan view of the first clamp in the clamp device in FIG. 1;

FIG. 4 is a front view of the first clamp in FIG. 3;

FIG. 5 is a left side view of the first clamp in FIG. 4;

FIG. 6 is a right side view of the first clamp in FIG. 4;

FIG. 7 is a front view of the second clamp in the clamp device in FIG. 1; and

FIG. 8 is a right side view of the second clamp in FIG. 7.

### DETAILED DESCRIPTION OF THE INVENTION

The following is an explanation of a non-limiting example of the present invention with reference to the drawings.

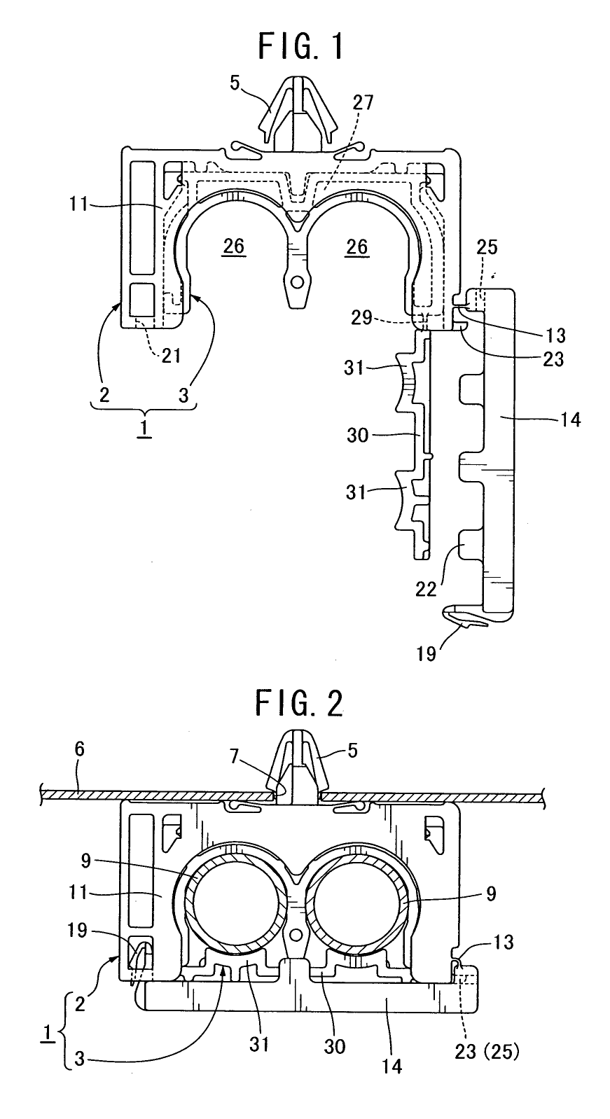

As shown in FIG. 1 and FIG. 2, a clamp device 1 for a pipe, in according with the present invention, comprises two components: a first clamp 2 and a second clamp 3. Each of the first clamp 2 and the second clamp 3 is preferably a single integral molded plastic product. The first clamp 2 is made of a strong, inexpensive, hard plastic material with non-heat-resistant properties (such as polyoxymethylene or POM). The second clamp 3 is made of a heat-resistant hard plastic material (such as polypropylene or PP) able to hold a high-temperature elongated component such as a heater pipe. The first clamp 2 is fixed by an anchor-shaped mounting device 5 to a support such as the underfloor of an automobile, and also holds the second clamp 3. The mounting device 5 can be some other type. For example, it can comprise a bore for accepting and engaging a standing bolt rising from the support. The second clamp 3 holds a high-temperature elongated component such as a heater pipe, as shown in FIG. 2, for example. The first clamp 2 is attached to a support such as the underfloor 6 of an automobile by inserting resilient legs of the mounting device 5 in a mounting hole 7.

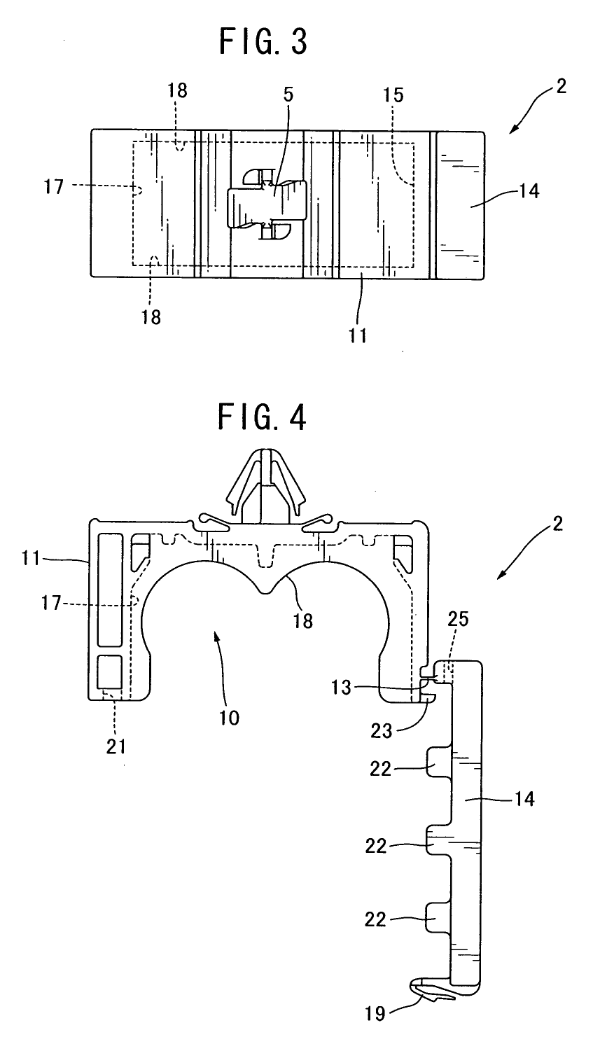

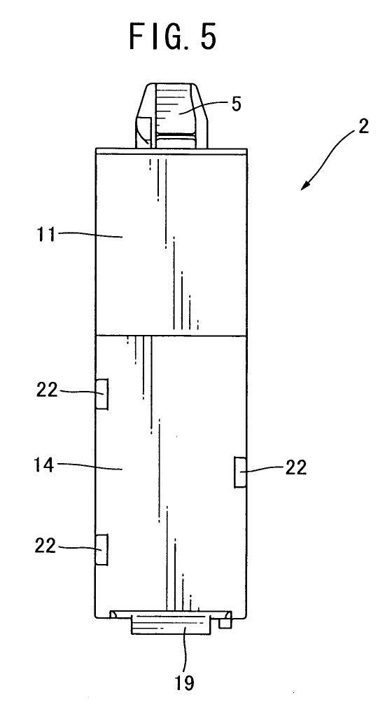

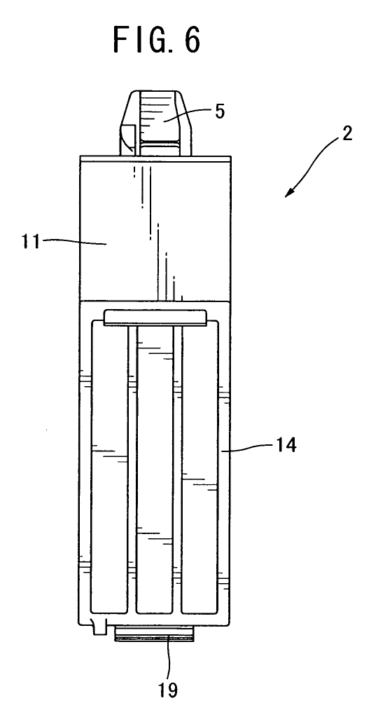

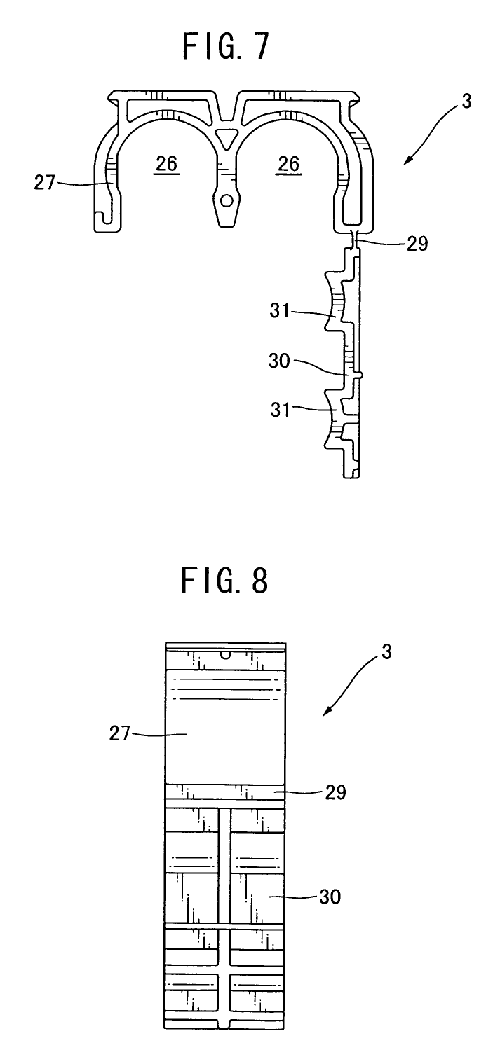

The first clamp 2 will now be explained in greater detail with reference to FIGS. 3 through 6, and the second clamp 3 will be explained in greater detail with reference to FIGS. 7 and 8.

As shown in FIG. 3 through FIG. 6, the first clamp 2 has a clamp holder 11 forming a recess 10 for accepting and holding the second clamp 3, and a first cover 14 connected via a hinge 13 to surround the second clamp 3 in the clamp holder 11. The recess 10 in the clamp holder 11 is large enough to accept the second clamp 3, and yet does not allow the second clamp 3 to move either longitudinally or transversely with respect to a pipe. The side walls 15, 17 and a portion of the clamp holder 11 restrict the movement of the accepted second clamp 3 transversely. End walls 18 are formed on both ends of the clamp holder 11 to prevent longitudinal movement of the second clamp 3 with respect to the pipe. A pawl 19 is formed at the tip of the first cover 14, which is inserted into a hole 21 in side wall 17 of the clamp holder 11 and latched. The first cover 14 is closed and latched so that the second clamp 3 accommodated in the recess 10 of the clamp holder 11 is surrounded. Ribs 22 are preferably formed on the first cover 14 extending to the side of the recess 10 to assist in restricting longitudinal movement of the second clamp 3 with respect to the pipe.

The hinge 13 is a thin plate that may break when the cover is closed. Therefore, a protrusion 23 and a recess 25 are formed near the hinge 13. When the first cover 14 is closed, the protrusion 23 is inserted into the recess 25 to strengthen the hinge region.

The following is an explanation of the configuration of the second clamp 3 with reference to FIG. 7 and FIG. 8. The second clamp 3 comprises a pipe holder 27 with two recesses 26 for accepting and surrounding high-temperature heater pipes 9, and a second cover 30 connected via a hinge 29 to the pipe holder 27 to surround the pipes accepted in the recesses 26. The second clamp 3 is dimensioned to be accommodated inside the clamp holder 11 of the first clamp 2. The recesses 26 are shaped so as to accept and surround pipes. These are typically semi-circular in shape as shown in the drawings. Protrusions 31 apply pressure to the pipes held in the recesses 26 when the second cover 30 is closed. No latching mechanism is installed on the second cover 30 in this example, but a latch could easily be installed, to improve retention strength for the held heater pipes 9.

The first clamp 2 and the second clamp 3 form a clamp device 1 as shown in FIG. 1. Here, the second clamp 3 is accommodated inside the recess 10 in the clamp holder 11 of the first clamp 2. The clamp device 1 is preferably attached to heater pipes 9 before it is sent to an automotive assembly line. Multiple clamp devices 1 can be attached at multiple locations if required. This eliminates the need to attach the clamp device 1 to the heater pipes on the assembly line and reduces the amount of labor that has to be performed on the assembly line.

In order to attach a clamp device 1 to heater pipes 9 at a particular location, portions of the heater pipes 9 at that particular location are accommodated inside the recesses 26 in the pipe holder 27 of the second clamp 3. By swinging the first cover 14 around hinge 13, the second cover 30 swings around hinge 29, the heater pipes 9 are surrounded in the second clamp 3, and the second clamp 3 is surrounded in the first clamp 2. When the pawl 19 on the first cover 14 is inserted into the hole 21, the first cover 14 and the second cover 20 are latched closed. When the first cover 14 is closed, the protrusion 23 enters the recess 25. As a result, the cover remains latched even if the hinge 13 breaks. The heater pipes 9 can be transported to an automotive assembly line with clamp devices 1 attached to the heater pipes 9 at several locations. On the assembly line, when a mounting device 5 on a first clamp 2 is inserted into a mounting hole 7 formed at that specific location on the underfloor 6, the heater pipes 9 are mounted at a specific location on the automobile underfloor. As a result, the mounting operation is easy and takes little time.

Preferably, the outer peripheral surface of the second clamp 3 is covered by a covering layer of a vibration-resistant elastic plastic material, and the first clamp 2 holds the second clamp 3 via the covering layer. This prevents the transmission of vibrations between an elongated component such as a heater pipe and a support such as an underfloor.

Also, by compressing the elastic material when the first clamp is holding the second clamp, high retention force can be obtained from a resulting reactive force. If the covering layer is hard to bond to the second clamp, bonding can be performed by subjecting the second clamp to insert molding using a vibration-resistant soft plastic material.

While preferred embodiments have been shown and described, changes can be made without departing from the principles and spirit of the invention, the scope of which is defined in the accompanying claims.

1. A clamp device for holding a high-temperature elongated component on a support, comprising:
a first clamp mountable to the support, and
a second clamp for holding a high-temperature elongated component,
wherein the first clamp includes a clamp holder for accepting the second clamp and a first cover for holding the second clamp in the clamp holder,
wherein the second clamp includes a component holder for accepting the high-temperature elongated component and a second cover for holding the high-temperature elongated component in the component holder,
wherein the first clamp is made of a non-heat-resistant hard plastic material, and
wherein the second clamp is made of a heat-resistant hard plastic material able to hold a high-temperature elongated component.

2. The clamp device described in claim 1, wherein an outer peripheral surface of the second clamp is covered by a vibration-resistant elastic plastic covering material layer, and wherein the first clamp holds the second clamp via the covering material layer.

3. The clamp device described in claim 1, wherein the second clamp is insert molded with a vibration-resistant elastic plastic material, and wherein a covering layer of the material is formed on an outer peripheral surface of the second clamp.

4. The clamp device described in claim 1, wherein the first cover is configured so as to be able to latch the second clamp inside the clamp holder, and wherein the second cover is configured so as to be able to latch the elongated component inside the component holder.

5. The clamp device described in claim 1, wherein the first cover is connected via a hinge to the clamp holder, and the second cover is connected via a hinge to the component holder.
